(19) United States
(12) Patent Application Publication
(10) Pub. No.: US 2005/0157812 A1
(43) Pub. Date: Jul. 21, 2005

(54) METHOD AND RELATED APPARATUS FOR REDUCING PEAK-TO-AVERAGE-POWER RATIO

(76) Inventors: Der-Zheng Liu, Tai-Nan City (TW); Kuang-Yu Yen, Tai-Chung City (TW); Kuo-Ming Wu, Nan-Tou Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/905,757

(22) Filed: Jan. 19, 2005

(30) Foreign Application Priority Data
Jan. 20, 2004 (TW) 093101585

(51) Int. Cl. H04K 1/02

(52) U.S. Cl. 375/296

(57) ABSTRACT

An apparatus for reducing a peak-to-average-power ratio includes a clipping signal detector coupled to the original time domain signal for generating an ideal clipping signal according to the original time domain signal, a clipping signal reconstruction unit coupled to the clipping signal detector for generating an actual clipping signal according to the ideal clipping signal, and a signal clipper coupled to the original time domain signal and the clipping signal reconstruction unit for generating a clipped time domain signal.

### BACKGROUND OF INVENTION

1. Field of the Invention

The present invention relates to a multi-carrier communication system, and more particularly, to a method and related apparatus for reducing a peak-to-average-power ratio of a multi-carrier signal.

2. Description of the Prior Art

Communication systems can be simply classified into single carrier communication systems and multi-carrier communication systems, wherein discrete multitone (DMT) and orthogonal frequency division multiplexing (OFDM) are two common multi-carrier modulation techniques. The multi-carrier modulation techniques have the advantages of high transmission rate and low channel variation, and thus are broadly applied to many kinds of communication systems, such as asymmetric digital subscriber loop (ADSL), wireless local area network (WLAN), digital audio broadcasting (DAB), digital video broadcasting-terrestrial (DVB-T), and so on.

However, several problems still remain to be solved to ensure the widespread use of multi-carrier communication systems. One of these problems is how to reduce the peak-to-average-power ratio (referred to as PAR). When a multi-carrier signal has a larger PAR, the power level of the time domain signal may sometimes lie beyond the range that the transmitter can linearly process. In such case, the peak of the time domain signal would cause the transmitter to enter a saturation condition, and an over-sized peak will be cut off. This leads to loss of information during transmission. Therefore, in order to maintain the integrity of the signal during transmission, the PAR of the multi-carrier signal must be reduced.

One of the methods for reducing PAR is known as “tone reservation”. The “tone reservation” method has the advantages of distortionless. However, it is difficult to find the solution to the optimal frequency for reducing PAR. Consequently, some researches propose to use a kernel signal iteratively for reducing the peak of a symbol to a clipping value. Though this method reduces the complexity, the latency is increased instead.

### SUMMARY OF INVENTION

It is therefore one of the objectives of the present invention to provide a method and related apparatus for reducing a peak-to-average-power ratio.

According to the claimed invention, a method for reducing a peak-to-average-power ratio of an original time domain signal is disclosed. The method includes generating an ideal clipping signal according to the original time domain signal, generating an actual clipping signal according to the ideal clipping signal, and generating a clipped time domain signal according to the original time domain signal and the actual clipping signal.

The present invention further provides an apparatus for reducing a peak-to-average-power ratio of an original time domain signal. The apparatus includes a clipping signal detector coupled to the original time domain signal for generating an ideal clipping signal according to the original time domain signal, a clipping signal reconstruction unit coupled to the clipping signal detector for generating an actual clipping signal according to the ideal clipping signal, and a signal clipper coupled to the original time domain signal and the clipping signal reconstruction unit for generating a clipped time domain signal according to the original time domain signal and the actual clipping signal.

These and other objectives of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a function block diagram of a PAR reduction apparatus according to an embodiment of the present invention.

FIG. 2 is a schematic diagram of a convolution filter for implementing the clipping signal reconstruction unit according to an embodiment of the present invention.

### DETAILED DESCRIPTION

A multi-carrier communication system uses a plurality of sub-channels that have different functions. In practice, some sub-channels serve to transmit data, some sub-channels serve to transmit pilot signals, some sub-channels serve as guard tones, and others are reserved as reserved sub-channels. According to the present invention, the reserved sub-channels of the multi-carrier communication system are used to locate frequency domain signals capable of reducing the peak-to-average-power ratio (referred to as PAR) of time domain signals. The method and related apparatus are illustrated as follows.

Assume that the channels that a multi-carrier communication system uses is a set N={0, 1, . . . N−1}, and the sub-channels that serve to locate PAR reduction signals are a subset R={k₀, k₁, . . . , k_{R}−1}, where RεN. According to the present invention, at first a transmitter transforms the data to be transmitted into an original frequency domain signal D, where D=[D₀, D₁, . . . , D_{N-1}]^{T}. Since the sub-channels of subset R are all reserved sub-channels, when nεR, Dₙ=0. Then the original frequency domain signal D is transformed into an original time domain signal d=[d₀, d₁, . . . d_{N-1}]^{T} by, for example, an Inverse Fast Fourier Transform (IFFT) as expressed in the following equation:

$$\begin{matrix}D = \frac{1}{\sqrt{N}} \cdot W \cdot D & ( 1 ) \\ Where W = [ \begin{matrix}{W}_{N}^{0 , 0} & {W}_{N}^{0 , 1} & ⋯ & {W}_{N}^{0 , ( N - 1 )} \\ {W}_{N}^{1 , 0} & {W}_{N}^{1 , 1} & ⋯ & {W}_{N}^{1 , ( N - 1 )} \\ ⋮ & ⋮ & ⋰ & ⋮ \\ {W}_{N}^{( N - 1 ) , 0} & {W}_{N}^{( N - 1 ) , 1} & ⋯ & {W}_{N}^{( N - 1 ) , ( N - 1 )}\end{matrix} ] & \\ is an IFFT transfer matrix , and & \\ {W}_{N}^{n , k} = {ⅇ}^{j \frac{2 π n k}{N}} . & \end{matrix}$$

Since the transmitter can only process time domain signals in a limited range, the time domain signal must be restricted under a clipping level μ, where the clipping levelμdepends on the transmitter. Accordingly, the transmitter can generate an ideal clipping signal c according to the original time domain signal d and the clipping level μ as shown in the following equation:

$${c}_{n} = \{ \begin{matrix}[ ( μ / \vert {d}_{n} \vert ) - 1 ] \cdot {d}_{n} , if \vert {d}_{n} \vert > μ \\ 0 , otherwise\end{matrix} , n = 0 , 1 , … , N - 1 \qquad ( 2 )$$

The PAR reduction signals, however, have to be located in the subset R, and thus the actual time domain clipping signal c′ must meet the following equation:

$$\begin{matrix}{c}^{′} = \frac{1}{\sqrt{N}} \cdot {W}_{R} \cdot {C}_{R} & ( 3 ) \\ where {W}_{R} = [ \begin{matrix}{W}_{N}^{0 , {k}_{0}} & {W}_{N}^{0 , {k}_{1}} & ⋯ & {W}_{N}^{0 , {k}_{R - 1}} \\ {W}_{N}^{1 , {k}_{0}} & {W}_{N}^{1 , {k}_{1}} & ⋯ & {W}_{N}^{1 , {k}_{R - 1}} \\ ⋮ & ⋮ & ⋰ & ⋮ \\ {W}_{N}^{( N - 1 ) , {k}_{0}} & {W}_{N}^{( N - 1 ) , {k}_{1}} & ⋯ & {W}_{N}^{( N - 1 ) , {k}_{R - 1}}\end{matrix} ] & \end{matrix}$$

is an R-to-N IFFT transfer sub-matrix, and C_{R}=[Cₖ_{₀} Cₖ_{₁} . . . Cₖ_{_{k−1}}]^{T} is the sub-vector of the PAR reduction signals.

Since W_{R}^{H}·W_{R}=R·I, the sub-vector of PAR reduction signals can be further derived by Eq. (3) and expressed as the following equation:

$${C}_{R} = \frac{\sqrt{N}}{R} \cdot {W}_{R}^{H} \cdot c \qquad ( 4 )$$

Therefore, the actual time domain clipping signal c′ is obtained as follows:

$$\begin{matrix}{c}^{′} = \frac{1}{\sqrt{N}} \cdot {W}_{R} \cdot {C}_{R} = \frac{\sqrt{N}}{R} \cdot {W}_{R} \cdot {W}_{R}^{H} \cdot c = {Ω}_{R} \cdot c & ( 5 ) \\ where {Ω}_{R} = [ \begin{matrix}{Ω}_{R}^{0 , 0} & {Ω}_{R}^{0 , 1} & ⋯ & {Ω}_{R}^{0 , ( N - 1 )} \\ {Ω}_{R}^{1 , 0} & {Ω}_{R}^{1 , 1} & ⋯ & {Ω}_{R}^{1 , ( N - 1 )} \\ ⋮ & ⋮ & ⋰ & ⋮ \\ {Ω}_{R}^{( N - 1 ) , 0} & {Ω}_{R}^{( N - 1 ) , 1} & ⋯ & {Ω}_{R}^{( N - 1 ) , ( N - 1 )}\end{matrix} ] & \\ = \frac{\sqrt{N}}{R} \cdot {W}_{R} \cdot {W}_{R}^{H} & \end{matrix}$$

In equation (5), the matrix ΩR is the transfer matrix corresponding to the reserved sub-channels (also referred to as kernel matrix). The actual clipping signal is therefore expressed as the following equation:
x′=d+c′ (6)

Since the kernel matrix is decided according to the location of the reserved sub-channels, when the location of the reserved sub-channels is fixed, the kernel matrix is a fixed matrix. As long as the kernel matrix is fixed, the high PAR problem of the multi-carrier signals is solved.

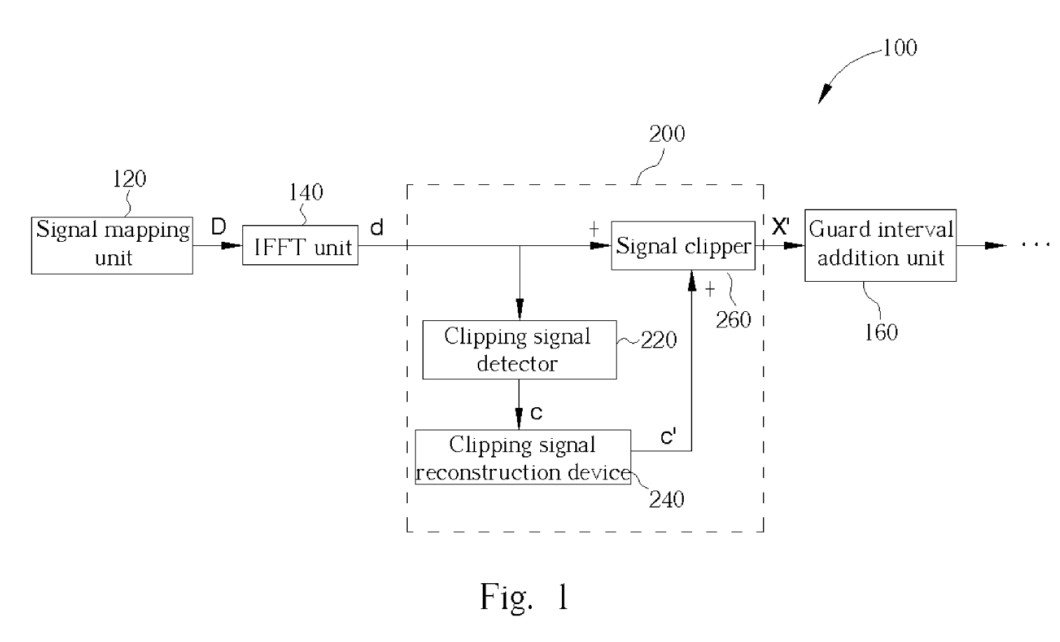

Please refer to FIG. 1. FIG. 1 is a function block diagram of a PAR reduction apparatus 200 according to an embodiment of the present invention. As shown in FIG. 1, the PAR reduction apparatus 200 is set in a multi-carrier transmitter 100. At first, a signal mapping unit 120 generates an original frequency domain signal D according to data to be transmitted. The original frequency domain signal D is then transformed into an original time domain signal d by an IFFT unit 140. The original time domain signal d is thereafter delivered to the PAR reduction apparatus 200, which is engaged in reducing the PAR of the original time domain signal d, for generating a clipped time domain signal x′. The clipped time domain signal x′ is then transmitted to other parts of the multi-carrier transmitter for further processing and delivering.

In this embodiment, the PAR reduction apparatus 200 includes a clipping signal detector 220, a clipping signal reconstruction unit 240, and a signal clipper 260. The clipping signal detector 220 calculates an ideal time domain clipping signal c by Eq. (2) according to the clipping levelμ. As described, since the PAR reduction signals have to be located in the subset R, the clipping signal reconstruction unit 240 needs to transform the ideal time domain clipping signal c into an actual time domain clipping signal c′ by Eq. (5) (If the location of the reserved sub-channels is fixed, the clipping signal reconstruction unit 240 only needs to perform simple operations by a fixed kernel matrix to obtain the actual time domain clipping signal c′). The signal clipper 260 adds the actual time domain clipping signal c′ to the original time domain signal d, and the clipped time domain signal x′ is obtained.

With reference to Eq. (5), one advantage of the present invention is that as long as the location of the reserved sub-channels is fixed, the kernel matrix Ω_{R} is fixed and is inherently a Toeplitz matrix. The Toeplitz matrix is characterized by Ω_{R}^{n,k}=Ω_{R}^{n+1,k+1} and Ω_{R}^{n,k}=(Ω_{R}^{n,k})*. Therefore, in practice a convolution filter can be used to implement the clipping signal reconstruction unit 240 of the present invention.

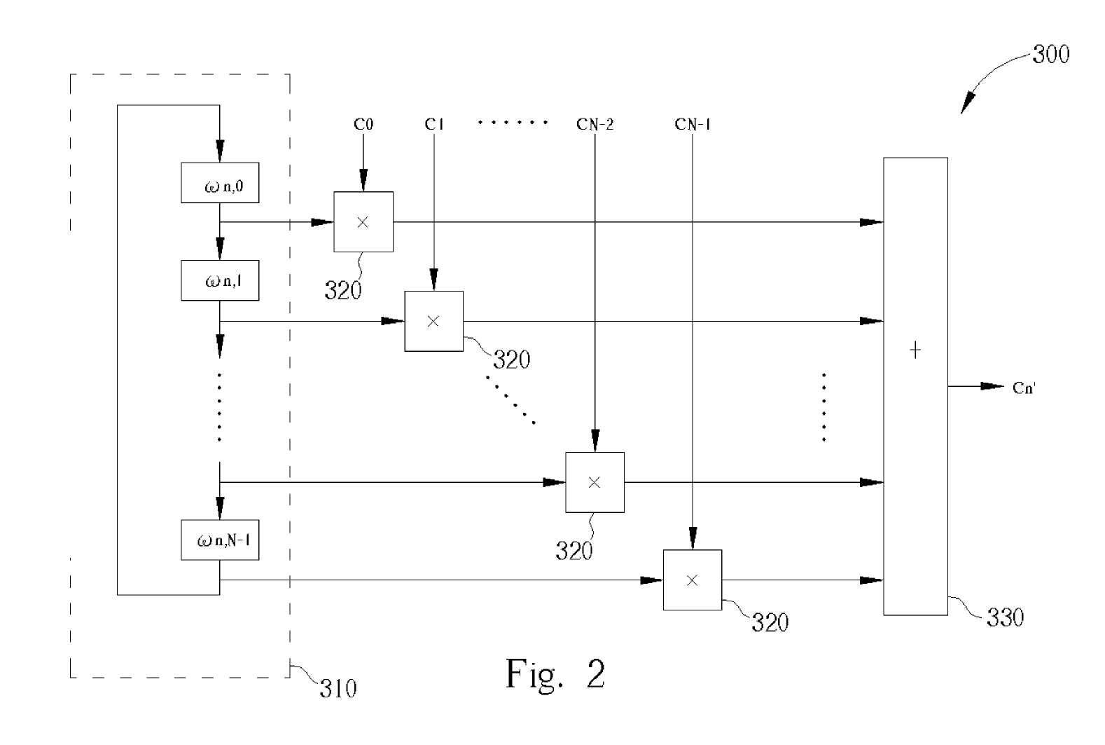

Please refer to FIG. 2. FIG. 2 is a schematic diagram of a convolution filter 300 for implementing the clipping signal reconstruction unit 240 according to an embodiment of the present invention. The convolution filter 300 includes an N-tap shift register 310, N sets of multipliers 320, and an N-tap adder 330. The N-tap shift register 310 stores data ωₙ=[ω_{n,0} ω_{n,1} . . . ω_{N-1}]^{T} which meets the following relation:
ωₙ₊₁=[ω_{n+1,0} ωₙ₊1,1 . . . ω_{n+1,N-1}]^{T}=[ω_{n,N-1} W_{n,0} . . . W_{n,N-2}]^{T}
where the initial value is
ω₀=[Ω_{R}^{0,0} Ω_{R}^{0,1} . . . Ω_{R}^{0,N-1}]^{T}, and the coefficient of the convolution filter 300 is c=[c₀ c₁ . . . c_{N-1}]^{T}. Consequently, the convolution filter 300 sequentially outputs the actual time domain clipping signal c′=[c′₀ c′₁ . . . c′_{N-1}]^{T}.

The present invention locates the PAR reduction signals in the reserved sub-channels, and thus does not result in any distortion of data, nor does it affect the efficiency of the multi-carrier transmitter. In addition, the present invention is implemented in time domain, and no signals are fed back to frequency domain necessarily. In addition, latency is reduced.

Those skilled in the art will readily observe that numerous modifications and alterations of the device may be made while retaining the teachings of the invention. Accordingly, the above disclosure should be construed as limited only by the metes and bounds of the appended claims.

1. A method for use in a signal processing system to reduce a peak-to-average-power ratio of an original time domain signal, the method comprising the following steps:
generating an ideal clipping signal according to the original time domain signal;
generating an actual clipping signal according to the ideal clipping signal; and
generating a clipped time domain signal according to the original time domain signal and the actual clipping signal.

2. The method of claim 1 wherein a clipping level is used as a basis, and the portion of the power level of the original time domain signal larger than the clipping level is the ideal clipping signal.

3. The method of claim 1 wherein the signal processing system is a multi-carrier signal transmitter, the multi-carrier signal transmitter uses a plurality of sub-channels where at least one sub-channel is reserved as a reserved sub-channel, and the actual clipping signal maps only to the frequency of the reserved sub-channel.

4. The method of claim 1 wherein the actual clipping signal is implemented in time domain.

5. The method of claim 1 wherein the actual clipping signal is generated by multiplying the ideal clipping signal by a transfer matrix.

6. An apparatus for use in a signal processing system to reduce a peak-to-average-power ratio (PAR) of an original time domain signal, the apparatus comprising:
a clipping signal detector for generating an ideal clipping signal according to the original time domain signal;
a clipping signal reconstruction unit, coupled to the clipping signal detector, for generating an actual clipping signal according to the ideal clipping signal; and
a signal clipper, coupled to the original time domain signal and the clipping signal reconstruction unit, for generating a clipped time domain signal according to the original time domain signal and the actual clipping signal.

7. The apparatus of claim 6 wherein the clipping signal detector detects a power level of the original time domain signal according to a clipping level, and outputs the portion of the power level larger than the clipping level as the ideal clipping signal.

8. The apparatus of claim 6 wherein the signal processing system is a multi-carrier signal transmitter, and the multi-carrier signal transmitter uses a plurality of sub-channels where at least one sub-channel is reserved as a reserved sub-channel, wherein the actual clipping signal generated by the clipping signal reconstruction unit maps only to the frequency of the reserved sub-channel.

9. The apparatus of claim 6 wherein the clipping signal reconstruction unit multiplies the ideal clipping signal by a transfer matrix for generating the actual clipping signal.

10. The apparatus of claim 9 wherein the signal processing system is a multi-carrier signal transmitter, and the multi-carrier signal transmitter uses a plurality of sub-channels where at least one sub-channel is reserved as a reserved sub-channel, wherein the transfer matrix is generated according to where the reserved sub-channel is located in the multi-carrier signal transmitter, and when the reserved sub-channel is fixed, the transfer matrix is a fixed matrix.

11. The apparatus of claim 9 wherein the transfer matrix is a Toeplitz matrix.

12. The apparatus of claim 6 wherein the clipping signal reconstruction unit is a convolution filter.

13. The apparatus of claim 6 wherein the convolution filter comprises:
a shift register for receiving the ideal clipping signal;
a plurality of multipliers coupled to the N-tap shift register for producing a plurality of output values according to a plurality of corresponding coefficients and the output of the N-tap shift register; and
an adder coupled to the multipliers for adding the output values to generate the actual clipping signal.

14. A signal transmitter comprising:
a transform unit for transforming an original frequency domain signal into an original time domain signal; and
a peak-to-average-power ratio (PAR) reduction circuit coupled to the transform unit for reducing the peak-to-average-power ratio(PAR) of the original time domain signal.

15. The signal transmitter of claim 14 wherein the transform unit is an IFFT (Inverse Fast Fourier Transform) unit.

16. The signal transmitter of claim 14 wherein a plurality of sub-channels are used and at least one sub-channel is reserved as a reserved sub-channel.

17. The signal transmitter of claim 14 wherein the PAR reduction circuit comprises:
a clipping signal detector for generating an ideal clipping signal according to the original time domain signal;
a clipping signal reconstruction unit coupled to the clipping signal detector for generating an actual clipping signal according to the ideal clipping signal; and
a signal clipper coupled to the original time domain signal and the clipping signal reconstruction unit for generating a clipped time domain signal.

18. The signal transmitter of claim 17 wherein the PAR reduction circuit operates in time domain.

19. The signal transmitter of claim 17 wherein the clipping signal reconstruction unit generates the actual clipping signal by multiplying the ideal clipping signal by a transfer matrix.

20. The signal transmitter of claim 19 wherein the transfer matrix is a kernel matrix, and when the reserved sub-channel is fixed, the transfer matrix is a fixed matrix.
